(19) United States
(12) Patent Application Publication
(10) Pub. No.: US 2003/0048256 A1
(43) Pub. Date: Mar. 13, 2003

(54) Computing device with roll up components

(76) Inventor: Peter C. Salmon, Sunnyvale, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/237,524

(22) Filed: Sep. 6, 2002

Related U.S. Application Data
(60) Provisional application No. 60/318,272, filed on Sep. 7, 2001.

(51) Int. Cl. G09G 5/00

(52) U.S. Cl. 345/168

(57) ABSTRACT

This specification describes techniques for building lightweight computing devices that may weigh less than one pound. The computing device may include a motherboard, a keyboard, and a display. Alternatively it may include a motherboard, a display, and speech-processing capabilities. The motherboard is preferably built on a flexible substrate using a rigid carrier. IC chips are attached using flip chip bonds that employ stud bumps on the IC chips, and corresponding wells filled with solder on the motherboard. The display and keyboard roll up when not in use and employ super-elastic materials as stiffeners. The computing device may be implemented as a mobile computer, and may include a camera, and biometric security features. Passive cooling is employed, using the area of the roll up devices.

### RELATED APPLICATIONS

This application claims priority to Provisional Application Serial No. 60/318,272 filed Sep. 7, 2001.

### BACKGROUND OF THE INVENTION

1. Field of the Invention

The present invention relates to computing devices and particularly to computing devices with elements that roll up when not in use.

2. Description of the Related Art

A new manufacturing process described herein provides dense assemblies of integrated circuit, IC, chips on flexible substrates with good rework capabilities for removing and replacing defective chips. The motherboard of the current invention is preferably manufactured with this process. It includes fabrication of a flexible multi-layer interconnection circuit on a rigid carrier, assembling, testing and reworking all of the components, and removing the carrier when done. A metal trace width of 5 microns or less is achievable, with a trace pitch of 10 microns or less. A release layer is employed so that the completed flexible circuit assembly can be easily peeled away from the carrier. Flip chip assembly methods are used, preferably using gold stud bumps at input/output, I/O pads of attached components, and corresponding wells filled with solder on the motherboard. A bonding pad pitch of 100 microns or less is achieved. The normal practice of providing an epoxy under-layer under flip chip bonded IC chips is avoided, and this contributes to a robust rework capability.

Capacitive sensing keyboard devices are known in the art, including touch pads and fingerprint sensors. Fingerprint sensors typically require a conductor pitch of around 25 microns in order to accurately detect the ridges and valleys of a fingerprint, with multiple interconnection layers required for the active capacitance sensing method of the preferred embodiment. The minimum pitch available with conventional flexible circuits is typically around 100 microns, so fingerprint sensors have generally been produced on silicon wafers using the high-resolution capabilities of IC chip fabrication methods. The keyboard of the current invention includes the conventional keys for typing, plus a touch pad and a fingerprint sensor, all integrated onto a single monolithic flexible substrate, using the fine feature capabilities of the current invention. Thin film transistors, TFTs, are preferably employed to provide the switching transistors of the keyboard back plane. The keyboard back plane is the two-dimensional array of switching elements and interconnections required to support a two-dimensional matrix of active capacitance sensors. The flexible keyboard is laminated with a sheet of super-elastic material for stiffness when extended for use in its planar form.

Super-elastic materials are used to stiffen the portions of the display and the keyboard that are extended for use. A suitable super-elastic material is Nitinol, an alloy of Ni and Ti, which is also known as a shape memory alloy. “Shape memory” refers to its behavior of returning to a “remembered” shape when an applied stress is removed. In the current application, the shape memory alloy is stressed by bending forces that are applied when the devices are rolled up for storage. The super-elastic material is in the form of a cold-rolled sheet with a preferred thickness of around 50 microns. The sheets are laminated with the flexible substrates of the keyboard and the display after they have been separated from their glass carriers. Nitinol transitions between two phases at its glass transition temperature, Tg. The austenite phase is present above Tg and is hard and super-elastic. The martensite phase is softer and is present below Tg. The preferred Nitinol alloy of the current invention has Tg equal to approximately 10° C., to accommodate operation of the host computer at temperatures above 10° C. A typical office room temperature is 20° C. Each time the mobile computer is used, portions of the keyboard and display go through a deployment cycle starting with a rolled up state, transitioning to an extended state during use (planar in form), and returning to the rolled up state for storage when done (cylindrical in form). The super-elastic property allows the roll up devices to transform millions of times between rolled up and extended states without taking on a set, particularly if the maximum strain is limited to 1% as in the current invention. Suitable sheets of Nitinol are becoming commercially available for this type of application.

A developing art exists for light emitting displays that emit light directly, rather than modulating light from a source such as a backlight. The display back plane is the array of switching elements and interconnections provided for controlling light emission at each pixel of the light emitting display. The switching elements are generally thin film transistors, TFTs, similar to those employed in liquid crystal display, LCD, panels. Organic light emitting diode, OLED, displays are currently in a rapid state of development. Light emitting polymer, LEP is another name for such displays. Flexible OLEDs or FOLEDs have also been described. Small displays have been integrated into commercial products, and some as large as having 12-inch diagonal screens have been introduced. Most of these displays are bottom-emitting; this means that they are designed to emit light through the substrate, using transparent indium tin oxide as the anode conductor. Top-emitting displays (TOLEDs) have also been described; their light does not pass through the display substrate. These are also referred to as transparent cathode displays. For good color rendition, the substrate for a bottom-emitting display must be transparent and clear. Clear flexible plastic films have been described as substrates for bottom-emitting displays including PET, poly ethylene terepthalate (polyester), and PES, poly ether sulfone. These substrates can be subjected to temperatures as high as 200° C. for brief periods. To take advantage of this capability for the manufacture of display circuits, methods of fabricating TFTs using polysilicon as the semiconductor material have been developed, wherein the processing temperature does not exceed 200° C. Once the display back plane is in place, organic materials must be provided to bridge between the anode and cathode of each light emitting diode. Ink-jet printers have been adapted to precisely dispense these organic materials at each pixel site of an OLED display.

The current invention uses a photo sensor to capture a live image of the user as he or she operates the mobile computer. Sensors may be charge coupled devices, CCDs, or complimentary metal oxide semiconductor, CMOS, sensors that are known in the art. An alternative approach is described by Gang Yu and Alan J. Heeger, “High-efficiency polymer photodiodes and their applications to image sensors”, Materials Research Society, Spring '97. They have noted that an OLED can be run backwards to generate current from incident light. If OLED structures are employed to create the light emitting display, it may be convenient and cost-effective to use a similar OLED structure for the photo sensor, using an imaging back plane of TFT switching elements and interconnections.

Fans are typically used to cool the electronic components of a computing device. However they are noisy and consume power. It is preferable to use convective cooling with ambient air. The preferred embodiment of the current invention combines the surfaces of the enclosure, the display, and the keyboard into a single integrated heat sink, to provide an effective and reliable passive cooling system.

The following paragraphs of this section apply primarily to fabrication and testing of the motherboard and the display.

The number of input/output (I/O) connections required by integrated circuit (IC) chips is increasing, to several hundred for recent microprocessor chips. As verification of complex designs becomes an ever-increasing portion of the total design activity, it is desirable to increase the I/O count further, to provide faster access to more internal nodes for testing. Flip chip assembly methods have helped to provide more I/O connections because they provide an area array of connections across the entire face of an IC chip, rather than just at the perimeter as with wire bonding. However, it continues to be desirable to reduce the pad pitch, the distance between bonding pad centers, in order to achieve more I/O connections per unit area of IC chip.

A recent advance in flip chip assembly capability has been the introduction of stud bumping machines that can provide gold stud bumps on IC chips with pad pitches of less than 100 microns. However, to take advantage of this capability, the motherboard that receives the bumped devices must have fine traces in order to route all of the signals with space efficiency, and to support bonding pitches less than 100 microns. The most recent packaging technology to be commercially introduced is called land grid array, LGA. It builds up the wiring layers by plating a base layer of copper that has been patterned with photo resist. The external terminal pitch claimed for this packaging method is “less than 0.5 mm”. None of the available printed circuit board technologies can support direct mounting of bumped devices at a pitch of 100 microns or less. The motherboard and display circuit assemblies of the current invention are capable of pad pitches of less than 100 microns, including a viable method for reworking defective IC chips at this bonding density.

For many years the minimum trace width available from printed circuit board vendors has been around 100 microns. Recently, advanced multi-layer circuit processes have achieved trace widths of 17 microns. The current invention is capable of achieving trace widths of 5 microns or less, together with a trace pitch of 10 microns or less.

One way to achieve fine line interconnection circuits is to employ a semiconductor fabrication facility and to build the interconnection circuit on a silicon wafer; hence the term, wafer level packaging, WLP. The precision of the associated photolithographic methods, the clean room environment with low particulate count, and the advanced substrate handling equipment of such a facility can all contribute to high-density interconnection circuits. However, the application of IC chip manufacturing facilities to this problem is more than what is required. An intermediate alternative is to apply the manufacturing resources of a glass panel fabrication facility, where the minimum feature sizes are 10 to 20 times larger than for IC chips (but still adequate for the most advanced assembly processes), and the manufacturing cost per unit area of devices produced is less than 5% of the cost per unit area of IC chips. In addition, the glass panel fabrication facility can produce system boards of any size up to more than a meter square, whereas the largest wafers produced have a diameter of 300 mm. In order to avoid the rigidity and weight of the carrier, and to provide better thermal access to the heat producing components for cooling them, it is preferable to discard the carrier after most of the processing is done.

Typically, WLP has used redistribution circuits to map from the fine pitch available with flip chip bonding to the coarser pitch of a printed circuit board. The current invention eliminates the redistribution circuits because the motherboard includes fine features that easily accommodate the fine pitch of the flip chip bonding.

It has been common practice to produce printed circuit boards at one facility, and perform system assembly and test at another facility. However, there are major advantages to integrating the circuit board manufacturing process with the assembly and test process to create a single, unified, fabrication, assembly, and test process. One advantage is in reducing the time to develop and debug a new design. Flexibility in the proposed process allows adaptation to component and assembly yield problems as they arise (as each additional component is assembled), providing more detailed testing sequences as necessary. For example, during prototype testing, components may be assembled onto the circuit substrate one at a time, providing a test environment of a partial system, and making the minimum change of a single IC chip between one test and the next. The test software can be adapted to address detailed issues as they arise. Once confidence has been achieved at this level, components may be assembled and tested in functional groups as the product moves into production. A tighter integration of personnel is also achieved because all of the variables are controlled in one place. This flexibility, wherein the assembly process is tailored to yield issues in real time, is not available with conventional testing methods. Usually, an entire system is assembled before any system testing is performed. A large batch of defective systems may be produced before any problem is identified. The current invention employs incremental system level testing, as each component is attached to the circuit assembly. Testing or yield problems have to be addressed before additional assemblies are produced. The testing of each component is performed fewer times, because the incremental assembly and test process essentially guarantees system integrity at each step. This contrasts with conventional methods requiring component test, sub-assembly test, and system test, with numerous iterations if problems develop.

More accurate and complete testing of components is provided when they are tested in their system environment, rather than individually. The system environment is created with the actual system, or a subset thereof, rather than a simulated environment created by test vectors programmed into a general-purpose tester. This can lead to lower test cost and faster test development, by eliminating the need to generate and debug detailed system response patterns. If the system level requirements are satisfactorily met, then the minutiae of component level characteristics become irrelevant. Alternatively, only the functions relevant to proper system function are tested; this is a much more manageable set of requirements than the total set of functions that all the assembled components are capable of performing.

The signal voltage swing is reducing with each new generation of IC chip technology. This makes it more difficult to test remotely through a cable, and still achieve the necessary noise margins. Providing test chips on the motherboard will provide shorter trace lengths for testing, which will be more robust with respect to both timing issues and noise margin.

By heating the glass carrier, each component may be verified at an elevated system temperature before attaching the next component. Greater emphasis can be placed on environmental stress testing at the motherboard or system level. Accelerated life testing can be performed early in the life cycle of a product, and lessons learned about particular components can be incorporated in the system level test sequences. A speed grade can be associated with the motherboard, as has been done in the past at the component level.

Such a unified process has only recently become feasible. It is helpful that common semiconductor manufacturing equipment can support fabrication of the interconnection circuits, bonding sites, and test connection fixtures. It is also helpful that sophisticated and programmable IC chips can now implement the testing function across all of the components in a system, including digital, analog, and RF functions, if multiple IC chips are employed for testing. Adding these functions to the motherboard using the current invention is not as expensive as in the past, because the packaging and assembly cost is minimal. Preferably, a tester is included with every module produced, but the cost of the tester is small compared with the system level assembly and performance benefits, and the reduction in system development time.

Generally flip chip bonding techniques require an epoxy under-layer between flip chip mounted IC chips and the circuit board. The purpose of the under-layer is to provide mechanical strength to withstand repeated thermal cycling without developing cracks in the area of the flip chip bonds. The thermal stress arises because of the difference in thermal coefficients of expansion (TCEs) between the IC chip material and the board material. Gelatinized solvents have typically been used to dissolve the epoxy; they leave a residue that must be cleaned off. The process of cleaning off the residue has typically resulted in damage to the fine pitch bonding sites, to the point where they cannot be reliably re-bonded. The under-layer is unnecessary with the current invention because the flexibility of the final interconnection circuit substantially eliminates thermally induced stress in the region of the flip chip bonds. Without the thermally induced stress, cracking will not occur. Thermal stresses are still present during assembly (because the interconnection substrate is rigid at this point), but are avoided during operation in the field (when the interconnection substrate is flexible). The number and extent of thermal cycles during assembly are more predictable and controllable than the thermal cycles arising from operation in the field. Environmental stress testing in the laboratory can be used to quantify the acceptable temperature limits, and assure crack-free circuit assemblies. Avoiding the under-layer makes a robust rework process possible. A related issue is the recent requirement for low stress in IC chips that use ultra-low-k dielectric materials. IC chips attached to flexible substrates will experience low stress and will accommodate the ultra-low-k dielectrics. This general concept is referred to in the art as compliant packaging technology.

### SUMMARY OF THE INVENTION

A range of computing devices can be assembled from four primary components: enclosure, motherboard, keyboard, and display. The motherboard, keyboard, and display are built on flexible substrates, and preferably include butt joints for connecting between them. The butt joint arrangement is simplified if the motherboard assembly is inverted with respect to the keyboard and display assemblies. In the preferred embodiment, the butt joint is capable of connecting 150 traces, with a trace pitch of 2 mm.

The motherboard preferably includes multi-layer interconnection circuits with trace widths of 5 microns or less. The preferred method of fabrication includes using a glass panel manufacturing facility, similar to those employed for making liquid crystal display, LCD, panels. A polymer base layer is formed on a rigid carrier with an intermediate release layer. Glass is the preferred material for the carrier, but other materials may be used, providing they are rigid and dimensionally stable. Alternate layers of metal and dielectric are formed on the base layer, and patterned to create an interconnection circuit on the glass panel. A thick layer of polymer is deposited on the interconnection circuit, and openings in the polymer formed at input/output (I/O) pad locations. Solder paste is deposited in the openings to form wells filled with solder. Components such as IC chips are stud bumped and assembled onto the multi-layer interconnection circuits using flip chip bonding, wherein the stud bumps on the components are inserted into corresponding wells on the interconnection circuits. The IC chips are tested and reworked to form a tested circuit module, retaining the glass carrier for dimensional stability, until all testing and rework is complete. A high-density interconnection method for connecting to a tester is described. Motherboard packaging layers are applied at the top surface, and it is separated from its carrier. The assembly is then aligned with and bonded to the enclosure, which is preferably made of a strong lightweight metal such as a cadmium alloy.

A glass substrate for 5^{th} generation fabrication of LCD circuits is typically 1100 by 1250 mm in area, and 1.1 mm thick. A 7^{th} generation LCD fabrication facility handling 1800 by 1500 mm glass substrates has been announced. The glass carrier for the motherboard of the current invention can be of any size. However, the costs are lower if larger glass panels are used. The glass carrier provides mechanical support for all of the fabrication, component assembly, test, and rework process steps, and also has excellent dimensional stability. This dimensional stability transfers to the multi-layer circuits that are built up as a series of films on top of the glass. This transferred dimensional stability is a primary reason that fine line features such as trace widths less than 5 microns are possible with the current invention. It is also important however, that the final version of the interconnection circuit be flexible, because the flexibility leads to more robust rework processes for removing and replacing defective chips. The flexibility also allows bending or folding of the motherboard to accommodate the three-dimensional constraints of a particular system enclosure.

A release agent is applied to a glass panel substrate, except for a clear region near the edges. The clear region is characterized by high adhesion between the glass and the polymer base layer to be subsequently formed on the glass. The high adhesion region provides an anchor that firmly attaches the polymer to the glass around the perimeter of the panel. The release layer creates low adhesion between glass and polymer, so that after a circuit assembly has been built on top, it can be readily peeled off. Streets of high adhesion may also be provided at the perimeter of each interconnection circuit, instead of just at the edges of the glass carrier.

Alternate layers of metal interconnect and dielectric such as a photo-definable polymer are built up on the base layer. Two-level contacts are formed between adjacent metal layers, and stacked contacts are provided between groups of adjacent layers. Each input/output (I/O) pad of an assembled IC chip is a node of the multi-layer interconnection circuit. At the center of each I/O pad a stacked contact is preferably created, with stubs at every metal layer for convenient routing of traces. The base polymer layer, the dielectric layers and the metal layers are flexible, and when the multi-layer interconnection circuit is subsequently removed from the glass panel, it too is flexible.

While the interconnection circuit is still attached to the glass carrier, it is convenient to form wells filled with solder on the array of interconnection circuits, in large substrate form. Each well is designed to accept a stud bump of an attached component. Preferably, gold stud bumps are formed at I/O pads of all IC chips to be assembled. To create the wells a thick layer of polymer is applied on top of the interconnection circuit. Openings in this layer are formed at I/O pad bonding sites. The openings in the cured polymer layer form a mask, and solder paste is wiped over the mask to fill the openings, thus forming a well at each of the I/O bonding sites.

Dicing the glass carrier with a diamond saw separates motherboards, displays, keyboards and other circuits from one another, and may provide a more convenient substrate size for component assembly, test, and rework. Each interconnection circuit must itself be tested, before any assembly is done. This is performed using a test fixture that connects through a module access port to an external tester. The module access port may include I/O pads (module access pads) for every node of the multi-layer interconnection circuit. The assembly and rework steps require that IC chips and other surface mounted components are precisely located in order that the bonding tool can accurately align bonding sites on the components with corresponding bonding sites on the interconnection circuit. Accordingly, the circuit assembly remains attached to the glass carrier, and its dimensional accuracy is maintained until these steps are completed.

In the preferred embodiment, a cable is attached to each motherboard assembly, for connection to the external fingerprint sensor. The motherboard assemblies are then separated from their individual glass carriers by peeling the base substrate away from the carrier. Since the adhesion force is low in these regions, they can be separated without damage.

In the preferred embodiment it is desired to built an integrated keyboard device, including the regular keys for typing, a touch pad, and a fingerprint sensor, all on a single monolithic flexible circuit. This integrated keyboard is preferably thin and flat, and rolls up when not in use. Francois Jeanneau, “Silicon fingerprint sensor enables low cost security”, www.PlanetAnalog.com, May 20, 2002, has described an active capacitance sensing method for detecting the ridges and valleys of a fingerprint. This active capacitance sensing method is also applicable to detecting key touches during typing, and the location of a fingertip on a touch pad. To sense which of the keys has been touched, the location of a fingerprint on a touch pad, or to sense the separate ridges and valleys of a fingerprint, a matrix of sensors is required, with switching elements at each pair of sensing electrodes to control the active measurement sequence. In the preferred embodiment of the current invention, a back plane of TFT switching elements and interconnections supports all three functions: key sensing, touch pad sensing, and detailed fingerprint sensing. The preferred substrate is a flexible material such as Kapton, a polyimide manufactured by DuPont. The keys are delineated on the keyboard surface by texturing the surface between the keys. A thin passivating layer of a material such as Parylene is applied. The flexible keyboard circuit is laminated with a sheet of Nitinol to provide a stiff planar device that can be rolled up for storage.

The display and the image sensor are also built on a flexible substrate. Like the keyboard back plane, the display back plane also requires fine line circuits and is preferably implemented on a glass carrier. In the first preferred embodiment, a top-emitting display is built on a flexible substrate material, preferably a polyimide such as Kapton, which is an amber color and is opaque at the desired thickness of around 50 microns. In the second preferred display embodiment, a bottom-emitting display is built on a clear flexible substrate material. For a large high-resolution display that can be refreshed rapidly to support streaming video, an active matrix display is preferred. Thin film transistors, TFTs are included in the display back plane, and work in cooperation with high performance display drivers implemented on IC chips to provide displays with fast refresh capability. These IC chips are mounted on the lower portion of the flexible display substrate, preferably using the flip chip assembly method. The IC chips include display drivers, the image-sensing element, and support chips for the image-sensing element. Communication of display information is preferably at a high level, such as using the PostScript display language, in order that complex visual content can be communicated between the display component and the motherboard using only the limited number of I/O connections provided by the butt contact. An alternative approach is to use the high density interconnect capability of module access ports on the motherboard and display component, and connect between them with a high density module cable. A further alternative is to use an edge connection means of the current invention, with a contact pitch of less than 200 microns. With either of these high-density connections, the display information can be communicated from the motherboard using lower level data structures such as bit maps with various encoding methods to compress the data. After the display assembly is tested and complete, a passivation layer is applied, and the assembly is laminated with a sheet of super-elastic material for stiffening.

The preferred embodiment employs a low-density butt contact connection between motherboard and display, and between motherboard and keyboard. The display and keyboard components are aligned with and bonded to the enclosure at their fixed ends. The motherboard is also aligned with and bonded to the enclosure, taking care to align the butt contacts for proper electrical connection between the components.

### BRIEF DESCRIPTION OF THE DRAWINGS

FIG. 1 is a perspective view of the computing device of the current invention, deployed for use.

FIG. 2 is a cross-sectional view of the enclosure, with display and keyboard rolled up for storage.

FIG. 3A is a perspective view of the computing device of the current invention, in stored form.

FIG. 3B is a perspective view of an electronic latch in open position.

FIG. 3C is a perspective view of an electronic latch in closed position.

FIG. 4 is a plan view of the display, motherboard and keyboard flexible circuit assemblies, connected together.

FIG. 5A is a plan view of a butt contact used for an edge connection.

FIG. 5B shows an enlarged plan view of the contact structures of the butt contact.

FIG. 5C shows a cross-sectional view of the contact structures of the butt contact.

FIG. 6 is a schematic view of a capacitive sensing element such as for a fingerprint sensor.

FIGS. 7A-7C shows a corner fragment of a glass carrier in plan view, describing the process steps for creating a polymer base layer on a release layer.

FIG. 7D is a cross-sectional view of section DD of FIG. 5C, and shows the base polymer layer in relation to the release layer.

FIG. 8 is a plan view of interconnection circuits arrayed on a glass carrier.

FIGS. 9A-9E shows the process steps for creating the first few layers of an interconnection circuit, in cross section.

FIG. 10 is a cross-sectional view of a multi-layer interconnection circuit such as for the motherboard component.

FIG. 11A is a cross-sectional view of a stacked contact with trace stubs.

FIG. 11B is a plan view of a stacked contact with trace stubs.

FIG. 12 is a schematic plan view of a circuit node connecting between two I/O pads.

FIG. 13 is a plan view of the motherboard assembly.

FIG. 14 is a cross-sectional view of section XX of FIG. 13.

FIGS. 15A-15C shows details of the preferred flip chip assembly method for an IC chip.

FIG. 16A is a plan view of a fragment of the motherboard after additional processing to create the module access port.

FIG. 16B shows a test fixture, in relation to the motherboard assembly.

FIGS. 17A-17B shows details of the preferred method for connecting a module cable or a test fixture to a motherboard assembly, or to a display assembly.

FIG. 18 is a schematic of repeating pixel circuits for an OLED display.

FIG. 19 shows a summary flow chart of the process to create a tested motherboard assembly.

FIGS. 20A-20B shows details of a high-density edge connection in plan view.

FIGS. 20C-20D shows further details of the high-density edge connection in cross-section.

It should be understood that for diagrammatic purposes the figures are not drawn to scale.

### DESCRIPTION OF THE PREFERRED EMBODIMENTS

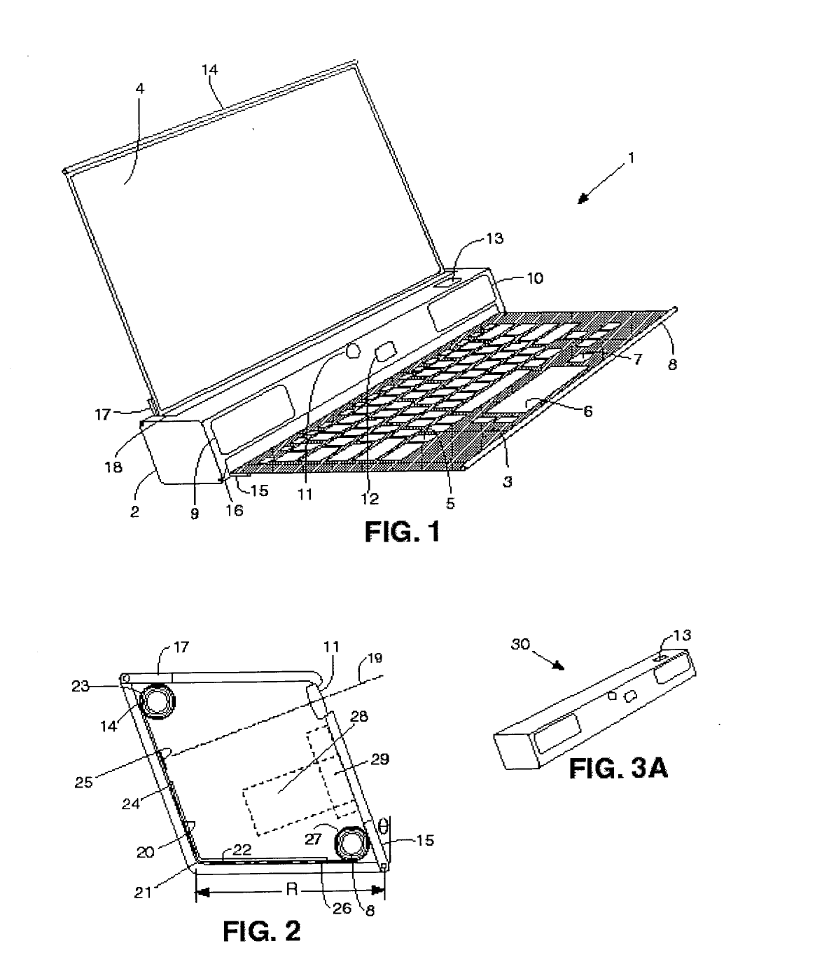

FIG. 1 shows computing device 1 of the current invention with keyboard and display extended for use. Enclosure, 2, keyboard, 3, and display, 4, are shown. Enclosure 2 is preferable fabricated from a lightweight metal alloy such as a cadmium alloy. Display 4 is preferably 12×9 inches in area, with a preferred resolution of 1024×768 pixels in the x and y directions, respectively. Individual keys, 5, a touch pad, 6, and a fingerprint sensor, 7, are shown on keyboard, 3. A roll up cylinder 8 is provided for rolling up the keyboard for storage, as will be described. A left speaker 9 and right speaker 10 are mounted on the front face of enclosure 2. A camera lens 11 is shown, and microphone, 12. An external fingerprint sensor 13 is shown, for validating and allowing entry to users when the mobile computer is in its stored state, and fingerprint sensor 7 on the keyboard is not accessible. A roll up cylinder 14 is also provided for the display. A trap door 15 is shown in the open position, allowing keyboard 3 to extend, and creating an open slot 16 where cooling air can enter. Trap door 17 is also shown in the open position, allowing display 14 to extend, and creating open slot 18 for cooling air to exit.

FIG. 2 shows a cross-sectional view of the computing device in its stored state, sectioned through lens 11 to show optical axis 19 of the imaging device. In the preferred embodiment, the cross-sectional shape of enclosure 2 is a rhombus with dimension, R, of approximately 2 inches, and angle, θ, of approximately 20°. The length of enclosure 2 is approximately 12.5 inches. A flexible motherboard 20 with attached components is mounted face down on two walls of enclosure 2, with a bend 21 at the corner as shown. Integrated circuit, IC, chips such as 22 are shown with their faces in contact with enclosure 2. Not shown are thin films coating IC chips 22 and a layer of conductive epoxy between IC chips and enclosure 2, provided for good thermal coupling. In the preferred embodiment, no fans are used, and natural convection of air over enclosure 2, extended keyboard 3, and extended display 4, provide all of the cooling required, as will be further described. A butt joint 24 provides electrical connection between motherboard 20 and rolled up display 23, having roll up cylinder 14 as its core. Image sensor 25 responds to light passing through lens 11, providing a head-and-shoulders view of the user (not shown). Another butt joint 26 connects motherboard 20 with rolled up keyboard 27 having roll up cylinder 8 as its core. Butt joints 24 and 26 each provide around 150 electrical connections at a 2 mm pitch, as will be further described. Dotted outlines 28 and 29 show possible locations for mounting speakers 9 and 10, a hard disk, and a power source such as a set of batteries or a fuel cell.

The method for storing the roll up components is as follows. For the keyboard, the user presses his or her fingers against roll up cylinder 8, and rolls cylinder 8 and the attached flexible keyboard toward enclosure 2. When rolled up keyboard 27 is safely inside enclosure 2, held by an index finger, the user lifts the outer edge of trapdoor 15 with another finger, and rotates it toward the closed position, while withdrawing the index finger. Once closed, trapdoor 15 is held in position with a lip of trapdoor 15 (not shown) engaging a corresponding detent in enclosure 2 (not shown), using latching structures known in the art. In addition, electronic latches may also be employed to support security features of the computing device, as will be further described.

The rhomboidal shape of enclosure 2 facilitates a similar operation for storing the display. The user rotates enclosure 2 through a 70° angle until display 4 is lying flat on the work surface. In a similar manner to the keyboard roll up technique, the user presses his or her fingers against rollup cylinder 14 and rolls the cylinder and the attached flexible display over the work surface, until the rolled up display is safely inside enclosure 2. By means similar to the latching trapdoor of the keyboard, trapdoor 17 is closed and latched to contain rolled up display 23.

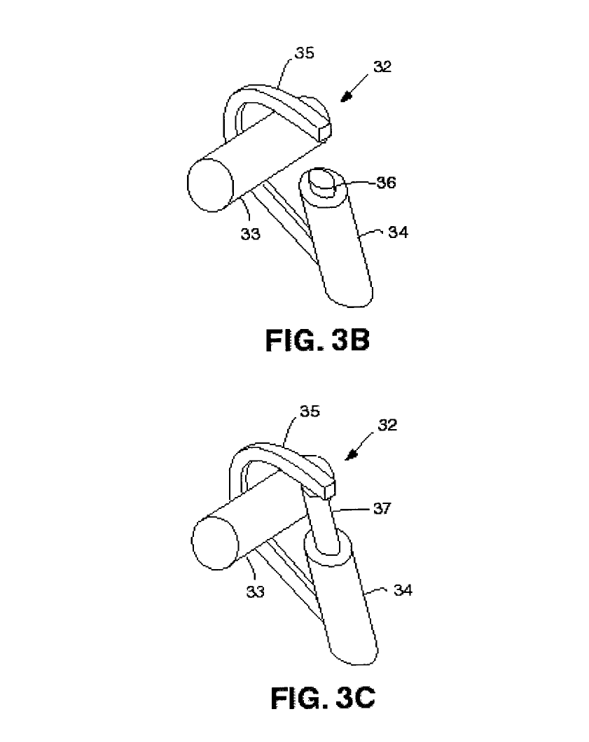

FIG. 3A is a perspective view of computing device 1 in its stored form, 30. Device 30 is small enough to fit in a handbag or briefcase. It may also be attached to a belt or loop of material worn by a user, or provided with a loop and stored on a hook. It may be carried in a pocket of the user. Alternatively, it may be fixed in position at a home, workplace, automobile, or airplane seat as examples, occupying a small amount of space, and extended for use when required. External fingerprint sensor 13 is available in this form of computing device 30.

FIG. 3B shows an enlarged view of an electronic latch 32 suitable for latching trapdoor 15 to enclosure 2. Latch 32 is opened and closed by control circuits on motherboard 3. A sturdy wire 33 is attached to the edge of trapdoor 15. Wire 33 is exposed for a short length near each end of trapdoor 17 (not shown) for engaging the mechanisms of a pair of electronic latches 32. Solenoid 34 and hook 35 are attached to enclosure 2 and are fixed in position. In FIG. 3B the pin of solenoid 34 is in its retracted position 36, allowing trapdoor 17 to close with wire 33 supported by hook 35. FIG. 3C shows that the pin of solenoid 34 has been extended to position 37 to latch wire 33 (and thereby trapdoor 15) in the closed position. As a default condition, solenoid 34 has its pin in extended position 37 when no power is applied, effectively locking trapdoor 15 closed. When the user puts his or her finger on sensor 13, processing circuits on motherboard 20 are activated from sleep mode to a processing mode. The user's fingerprint is then scanned to determine if he or she is authorized, based on comparison with previously stored replicas of fingerprints of all authorized users. Only if the user is authorized will the processing circuits on motherboard 20 command solenoid 34 to retract its pin to position 36 so that keyboard 3 can be extended for use. If the user is not authorized, the processing circuits may sound an alarm or send the fingerprint data to a base station for follow-up by security personnel. A similar form of electronic latch can be used to latch trapdoor 17.

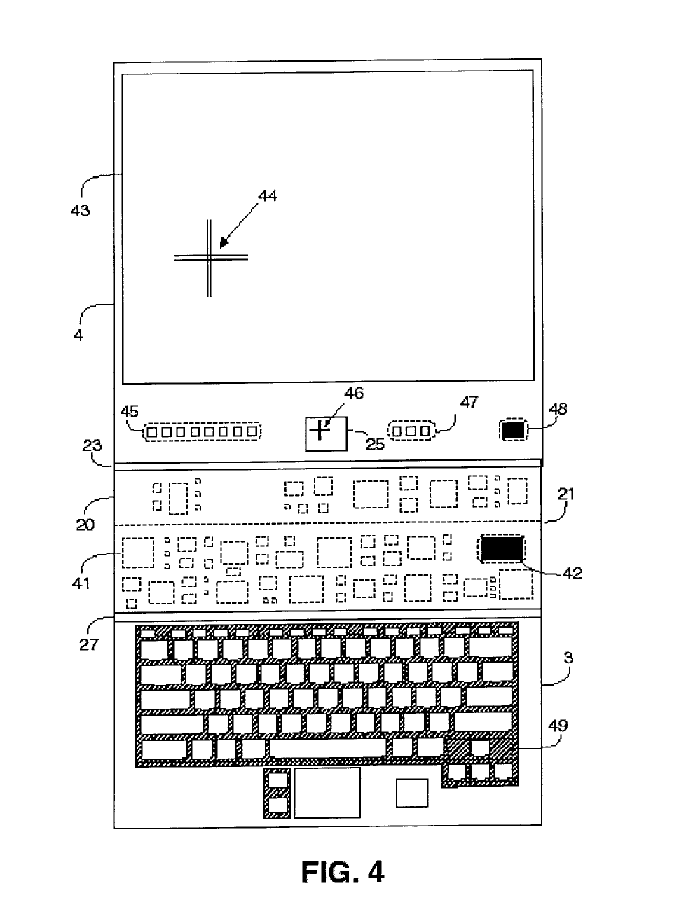

FIG. 4 shows motherboard 20, keyboard 3, and display 4 connected together using butt joints 27 and 23. Motherboard 20 is inverted with respect to keyboard 3 and display 4, so only the dotted outlines of assembled components such as IC chip 41 are shown. A module access port 42 on motherboard 20 is shown, as will be further described. Dotted line 21 locates the bend in flexible motherboard 20, and is clear of IC chips that would interfere with bending. The display screen 43 of display 4 is comprised of repeating pixel elements such as 44, as will be further described. A group of display driver IC chips 45 contains memory and drivers for pixel circuits 44. Imaging component 25 is shown as an IC chip with repeating pixel elements, 46. Image-sensing memory and driver circuits are contained in an image-sensing group of IC chips 47, associated with imaging component 25. When the user is operating computing device 1, light from the area of his or her head and shoulders will pass through lens 11 and arrive in focus at image sensor 25. In the preferred embodiment, lens 11 has a fixed focus for simplicity. However, the user's face is typically 15-18 inches from the display, and adequate depth of field will be possible for a sharp image of the head and shoulders area. The imaging system, including lens 11, image sensor 25, image sensing group 47 as well image processing circuits on motherboard 20 comprise a simple camera. The camera can be used to capture the image of a user making a video telephone call for example. It may be used as an added layer of security while an important matter is transacted using computer device 1. In this case, the identity of the user is made available to the user at the other end of the connection, which could be a bank officer, a law enforcement officer, or a military agent. This image would be transmitted by wireless means via a base station to a similarly equipped computing device.

Module access port 48 is part of display 4 and is used to test the display and image sensing circuits during and after fabrication. It may also be used to provide high-density interconnection means for connecting with motherboard 20 for testing, and in the deployed system. Surface texturing of keyboard 3 is shown, 49, as will be further described.

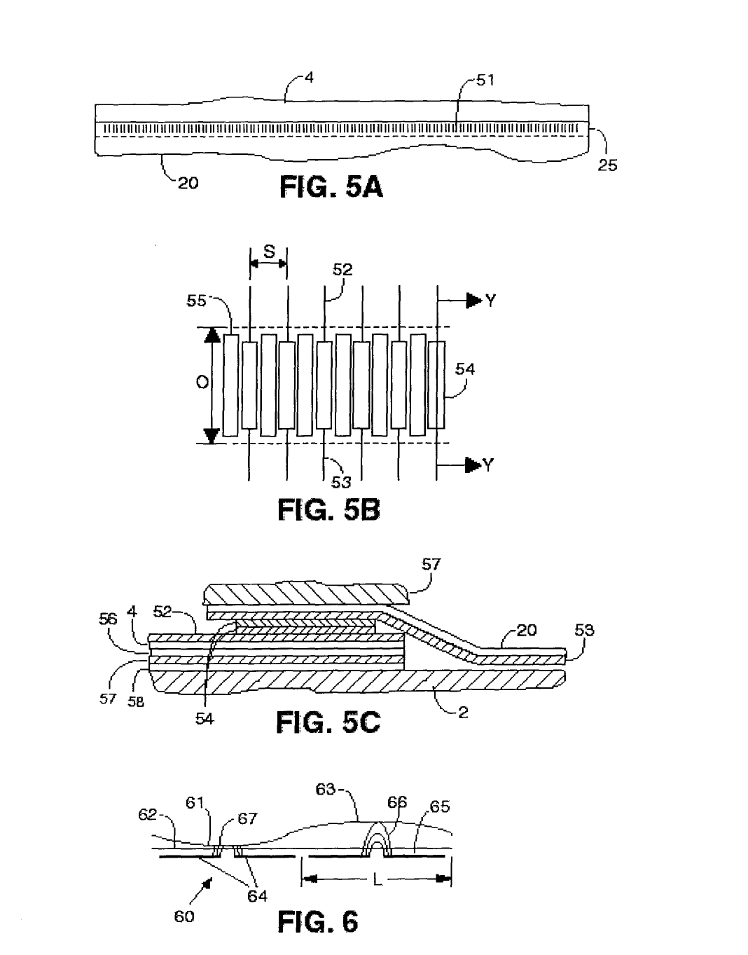

FIG. 5A shows butt joint 25 providing an edge connection between motherboard 20 and display 4. An edge pattern of conducting traces 51 is shown, with the traces arrayed at a constant pitch, perpendicular to butt joint 25. FIG. 5B shows an enlarged plan view of a small segment of butt joint 25. Traces 52 from display 4 connect with traces 53 from motherboard 20 using face-to-face pads 54. A tacky adhesive, 55, is provided as shown between pads 54. Tacky adhesive 55 provides a small bonding force during assembly, but allows the parts to be separated if necessary. The overlap of the two flexible circuits, O, is typically 4 mm, and the spacing between traces, S, is typically 2 mm. A high-density version of this edge connection with spacing of 200 microns or less will also be described. FIG. 5C is a cross-sectional view of section YY of FIG. 5B. Display trace 52 is on display circuit 4 which is bonded using adhesive layer 56 to super-elastic sheet 57 which is bonded using adhesive layer 58 to enclosure 2. Traces such as 52 and 53 are preferably aluminum, but may be other conductive materials. Face-to-face pads 54 are shown in contact. Pads 54 preferably include the following build-up of layers on the traces: an adhesion layer of aluminum, a layer of nickel, and a flash of gold for low contact resistance. The reverse sequence is shown for the motherboard side of the connection. Pad 54 is formed on trace 53 on motherboard 20. In place of adhesion layer 56, a clamping bar 57 is provided. It extends between opposite ends of enclosure 2, and compresses the stack of conductors shown in the figure to achieve good electrical contact, and to mechanically secure the overlapping flexible circuits in the region of the edge connection. The assembly sequence is as follows. Display circuit 4 is aligned with and bonded to enclosure 2 using adhesive layer 58. The motherboard assembly is then inverted with respect to display circuit 4, aligned, and pressed against it in the edge contact region, where it is temporarily secured by tacky adhesive 55. Clamping bar 57 is then installed to mechanically and electrically secure the connection. A similar sequence of steps may be used to make the edge connection between keyboard 4 and motherboard 20.

FIG. 6 shows an enlarged schematic view of a portion of a fingerprint in contact with a capacitive-sensing keyboard element, 60. A ridge of the fingerprint 61 is shown contacting surface 62 of capacitive sensor 60, and a valley of the fingerprint 63 is shown adjacent to a neighboring capacitive sensing element. Sensor 60 includes a pair of electrodes 64, and is covered with a thin flexible dielectric layer, 65. Dielectric layer 65 is preferably Parylene, but other materials may be used. Valley 63 of the fingerprint allows electrical field lines 66 to extend above surface 62 as shown. Conversely, ridge 61 of the fingerprint interrupts the field lines as shown 67. This difference can be detected using active sensing methods known in the art. Sensing elements 60 are arrayed in two dimensions with a typical repeat distance, L, of 50 microns. By sensing all the elements of a fingerprint sensor in a two-dimensional array, ridges 61 of a fingerprint can be mapped to form an electronic replica, to identify a user for security purposes. Similar structures and methods may be employed for keyboard keys 5 and touch pad 6. For keyboard keys, the presence or absence of a fingertip is the detected event. For a touch pad, the presence and location of a fingertip is the detected event. These structures and methods are known in the art.

Computer users are generally comfortable with conventional keyboards having separate keys and tactile feedback when a key is depressed. Since the keys of a flat keyboard of the current invention are not readily distinguishable, the user must have a way to find the right key when typing. This is achieved by texturing dielectric layer 65 to delineate the keys. This type of texturing is shown as 49 in FIG. 4. Dry plasma etching of layer 65 can provide texturing with a surface depth of a few microns, as is known in the art. The pads of the fingers can readily detect the difference between textured and un-textured surfaces, and the user can thereby find the keys using this form of tactile feedback. Although tactile feedback corresponding to key depression is unavailable with keyboard 3, it is possible to learn how to use the keyboard in “touch typing mode”. Software algorithms can be programmed to learn the typing behavior of individual users, and adapt to the peculiarities of each user. Audible feedback may also be employed, wherein an audible click or other aural response is provided following each key detection.

Some users may prefer to communicate with computing device 1 by voice. For these users, a version of computing device 1 may be produced with no keyboard. Rather, it will include IC chips for speech processing, and software to optimize the human interface for each individual user.

Having provided a system level description of computing device 1, the following paragraphs of this section will focus on manufacture of the motherboard display, and keyboard assemblies. These components all employ high-density interconnection circuits. The motherboard and display also include assembly of IC chips with closely spaced flip chip bonds.

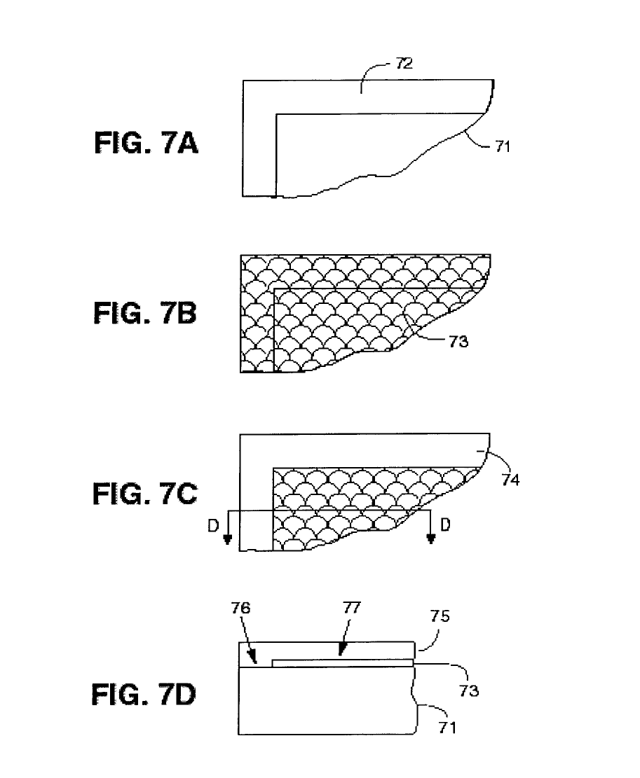

FIG. 7A shows a corner fragment of a glass carrier 71. Photo resist has been patterned on the carrier, so that a border of resist, 72, having a width of approximately 20 mm, surrounds the perimeter. FIG. 7B shows that a film of release layer, 73, has been applied over the entire surface of the glass carrier. A suitable material for the release layer is a fluorinated silicone such as F065 manufactured by Gelest, Inc., in Morrisville Pa., USA. This material is a single part gel. It can be applied as a fog or fine spray, or using the spin-on method. A suitable thickness is 2-5 microns after curing, with 2 microns preferred. A typical curing cycle is 125° C. for 25 minutes. This release material has a silane component that bonds well to glass surfaces, yet presents a fluid-like interface to polymeric materials like the base layer to be subsequently applied. FIG. 7C shows the result of lifting the resist to pattern the release layer, using a developer or resist stripper to swell the resist and effectuate the lift process; border 74 is clear of release material. A base layer 75 is then applied. Base layer 75 is preferably a polymer, and is applied in liquid form with a metering roll or using a spin-on or spraying method to coat the large substrate. A suitable polymer is Cyclotene, a polyimide manufactured by Dow Chemical. No adhesion promoters are used. After curing, a suitable thickness of base layer 75 is 40-80 microns, with 50 microns preferred. FIG. 7D is a cross-sectional view of section DD of FIG. 7C, and shows the relation between glass carrier 71, release layer 73, and base layer, 75. Surface region 76 is characterized by high adhesion between the base layer and the carrier, and surface region 77 is characterized by low adhesion between the base layer and the release layer. Base layer 75 may later be peeled off of surface region 77 without damage to the base layer or to circuits built thereon, to be further described. An alternative method for providing the base layer is to laminate a preformed sheet of polymeric material onto the glass carrier, while providing a strong adhesion in surface region 76 to anchor the edges of the sheet, and a weak adhesion in surface region 77 to facilitate later release.

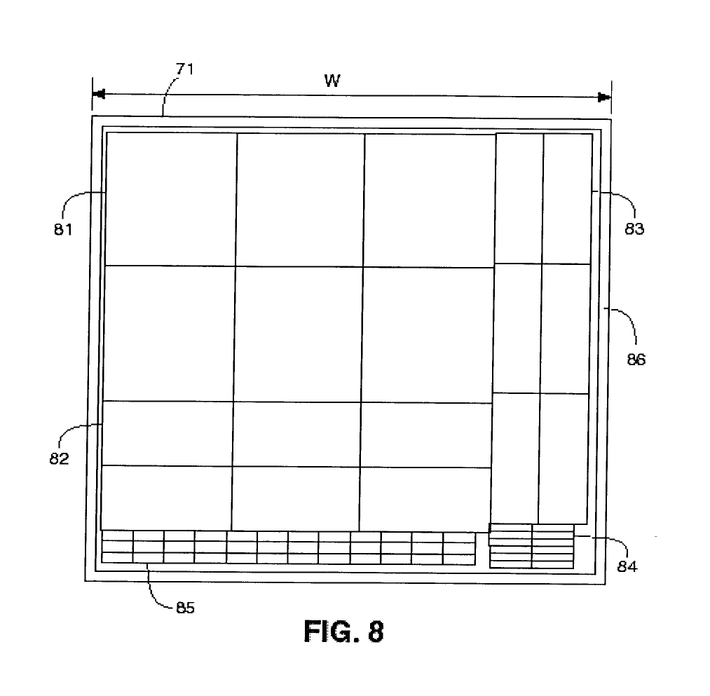

FIG. 8 shows glass carrier 71 with a width, W, of 1250 mm, typical of 5 th generation LCD panels. A 7^{th} generation facility has been announced that will handle substrates 1800 mm×1500 mm. Although any size glass carrier may be used, larger sizes result in lower costs for the associated circuit assemblies. Materials other than glass can be used for the carrier, providing they are rigid and dimensionally stable. Glass is preferred in the current invention because it is well characterized as a substrate material, and it is used with mature panel manufacturing methods such as for LCD fabrication. Sites for multi-layer interconnection circuits are shown arrayed across the glass carrier. In this example, interconnection circuits 81 measure 12.5 inches by 13 inches and correspond to display circuits of the current invention, interconnection circuits 82 measure 12.5 inches by 6.2 inches and correspond to keyboards of the current invention, interconnection circuits 83 measure 12.5 inches by 4.6 inches and correspond to motherboards of the current invention, interconnection circuits 84 measure 4 inches by 0.75 inches and correspond to flex circuits for connecting external fingerprint sensor, 13, of the current invention, to module access port 42 Interconnection circuits 85 measure 3 inches by 1 inch, and correspond with another circuit to be manufactured, for example the motherboard of a cellular phone. Border region 86 corresponds to high adhesion region 76 of FIG. 7. An alternative version of the layout represented in FIG. 8 includes streets of high adhesion provided between each of the interconnection circuits, included for improved dimensional stability of the interconnection circuits, and these streets are removed during the dicing operation. The cuts of the dicing operation must be performed in the proper order to extract all of the interconnection circuits with differing sizes.

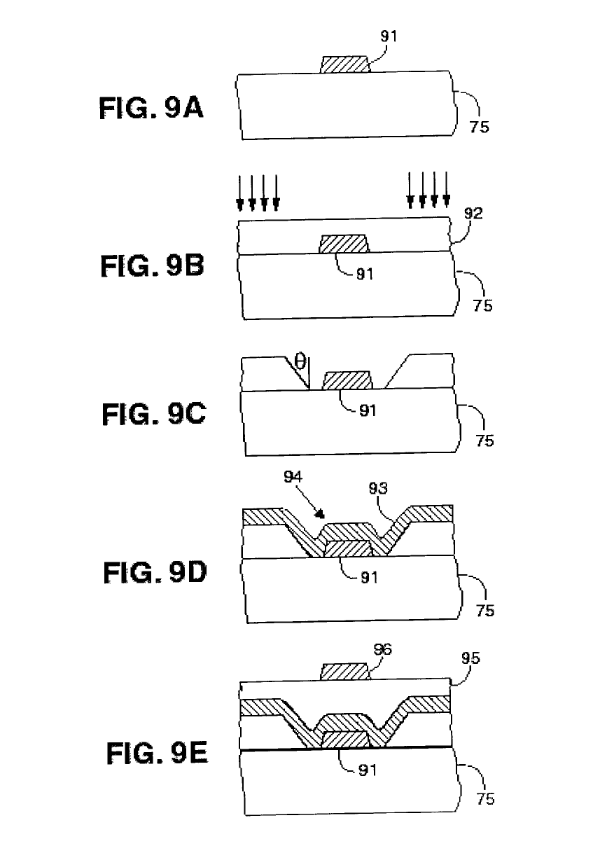

FIG. 9A-FIG. 9E represents the preferred method for forming thin film layers of a complex interconnection circuit such as motherboard 20 on base layer 5. The metal layers of motherboard 20 are preferably aluminum, deposited by sputtering in a vacuum chamber. A suitable thickness range is 1-2 microns, with 1 micron preferred. The metal layers are patterned using conventional photolithographic methods known in the art, and are preferably dry etched using plasma etching processes, also known in the art. The patterning of each layer typically includes coating with photo resist, exposing with light through a mask or reticule, developing the resist to form openings where the material is to be removed, and etching of the layer through the openings in the resist. Alternative metals may be used. In FIG. 9A a patterned trace of metal 91 is shown on base layer 75. For example, this trace has a width of 5 microns and a thickness of 1 micron. In FIG. 9B, the substrate and metal traces have been coated with a planarizing layer 92 of a photo-definable polymer. A suitable photo-definable polymer is photo BCB, benzocyclobutene, a photosensitive form of Cyclotene. The term “photo-polymer” shall be used hereinafter for this material. The photo-polymer is applied in liquid form to planarize the surface. A suitable thickness of photo-polymer layer 92 is 2-4 microns after curing, with 2 microns preferred. In FIG. 9B a masked region of photo-polymer has been exposed to light where the material is to remain. The effect of light on the photo-polymer is to form cross-linked molecules that become solidified (polymerized) and are not dissolved away in the subsequent development step. Polymer material that is not exposed to light is not cross-linked, remains in liquid form, and is removed by the development step. This is the same mechanism that occurs when patterning a negative photo-resist, and is referred to as negative image development. FIG. 9C shows the result of developing the polymer. The masked illumination of the exposure process causes photons to penetrate the surface of the polymer. The photons spread laterally as they penetrate the polymer, causing cross-linking as they spread. The net result is a tapered contact window with an angle, θ, of approximately 45°, as shown in FIG. 9C. FIG. 9D shows the result of depositing and patterning the next layer of metal, 93, to form the two-layer contact, 94 between traces 91 and 93. Because the contact window is tapered rather than vertical, good metal coverage is achieved at the contact walls. FIG. 9E shows the addition of the next photo-polymer layer 95, and patterning of the next metal layer as metal trace 96. The foregoing description teaches the formation of multi-layer interconnection circuits, by repeating the foregoing steps.

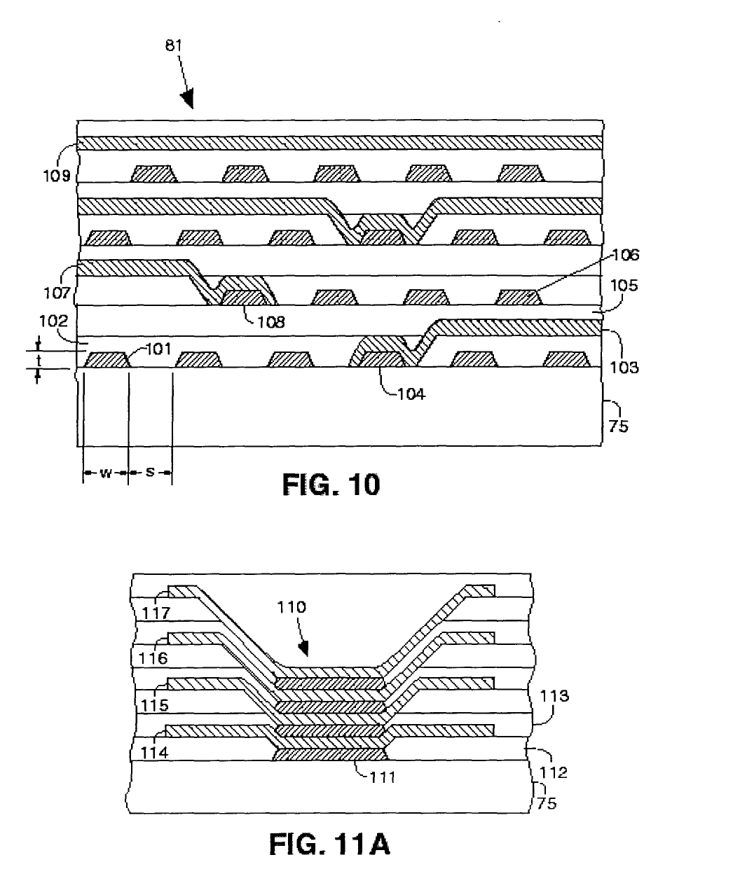

FIG. 10 is a cross-sectional view of motherboard 20 of the present invention. Base polymer layer 75 is shown. Conductive trace 101 of first layer metal is shown, with width, w, of 5 microns or less, spacing, s, of 5 microns or less, and thickness, t, of one micron in the preferred embodiment. It may be desirable to arrange conductors on alternate layers to be generally orthogonal as in the figure, as is common practice for layout efficiency. A planarizing layer of photo-polymer, 102, has been applied over the first layer metal pattern using a roller to meter the thickness, or using spin-on or spray-on methods, with a preferred thickness of two microns after curing. A trace of second layer metal, 103, forms a two-level contact with a trace 104 of first layer metal. The next photo-polymer layer 105 again has a preferred thickness of 2 microns, and covers second layer metal 103 with a thickness of 1 micron. Photo-polymer layer 105 provides a planar surface for deposition and patterning of a third layer metal such as trace 106. Trace 107 is fourth layer metal and connects using a two-level contact to a trace 108 of third layer metal as shown. Additional layers are built up in the same manner, as required, and in principle any number of metal layers can be provided. In the figure, trace 109 is on the eighth metal layer.

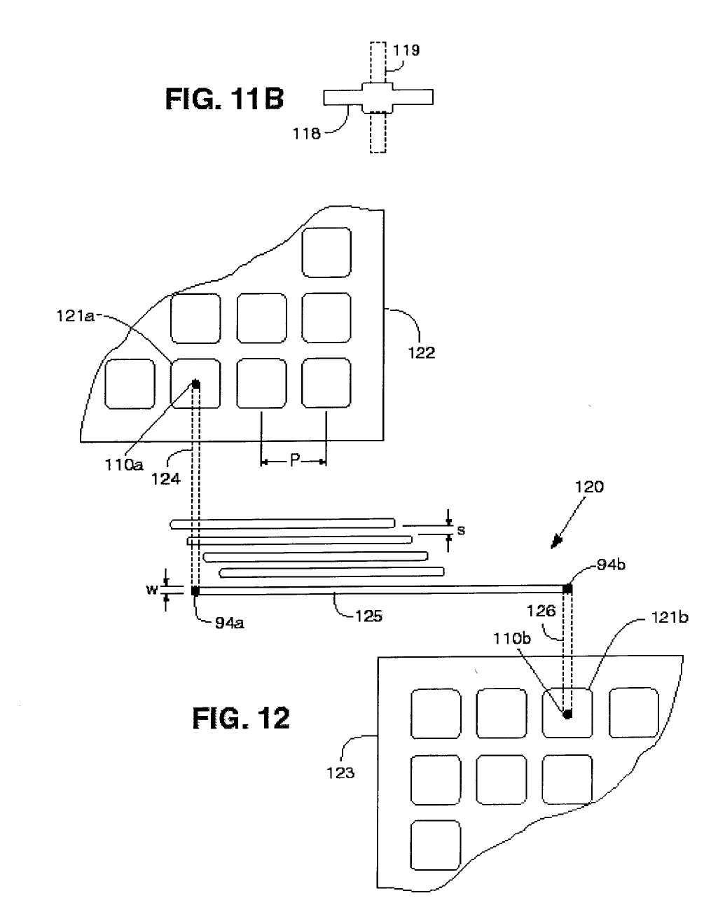

FIG. 11A shows an expanded cross-sectional view of a stacked contact 110. Metal traces on alternate layers are preferably orthogonal as shown. A trace 111 of first layer metal is shown with a suitable trace width of 8-12 microns in this contact structure, with 10 microns preferred. Planarizing layers of photo-polymer such as 112 and 113 are used between each metal layer, as described in reference to FIG. 9 and FIG. 10. Trace 114 of second layer metal contacts trace 111 as shown. A contact stack of all metal layers is built up layer by layer, with stubs provided for connecting metal traces at any level. Stubs are short metal traces that are provided to establish points of access at each metal layer. Most of them will never connect to anything else. However, some of them will be extended into circuit traces of the interconnection circuit. Trace stubs 114, 115, 116, and 117, are on metal layers 2, 4, 6, and 8, respectively. Similarly, at 90 degrees rotation from these stubs, the odd numbered metal layers also have similar stubs (shown in FIG. 11B). It may be convenient to build a stacked contact like 110 at all of the I/O pads. In this case the top metal layer would connect with the pad metal. The width of I/O pad metal is approximately 90 microns in the preferred embodiment, as will be further discussed, providing ample space for such a stacked contact. It is convenient for the circuit board layout designer to know that every node in the circuit is available at all metal layers (using the stubs), and at a known location. FIG. 1B shows a plan view of the stacked contact of FIG. 1A, revealing the locations of the stubs in the two orthogonal directions. The location of stubs on even-numbered metal layers represented by layer 8 is shown, 118, and stubs for odd-numbered metal layers are shown in dotted outline, 119.

FIG. 12 is a schematic plan view of a circuit node 120 that connects between an I/O pad 121a on IC chip 122, and I/O pad 121b on IC chip 123. A stacked contact 110a is shown at I/O pad 121a, as described in reference to FIG. 11. Trace 124 is on a metal layer below the surface layer, for example on metal layer 7 in a circuit with 8 metal layers. Trace 124 contacts using two-level contact 94a to trace 125 which is on metal layer 8 in this example. A set of parallel metal traces on layer 8 is shown, each trace having a width, w, of 5 microns or less in the preferred embodiment. The separation, s, between traces is also 5 microns or less in the preferred embodiment. The spacing between I/O pads, P, is 100 microns or less in the preferred embodiment. Circuit node 125 continues at contact 94b to trace 126 on metal layer 7 in the example, and terminates at I/O pad 121b using stacked contact 110b.

The details of building a high density interconnect structure in the form of motherboard, 20, have been described. The same techniques apply to display circuit 4 and keyboard 3. We shall now focus on assembly and testing of IC chips on the motherboard, as an example of a circuit assembly of the current invention.

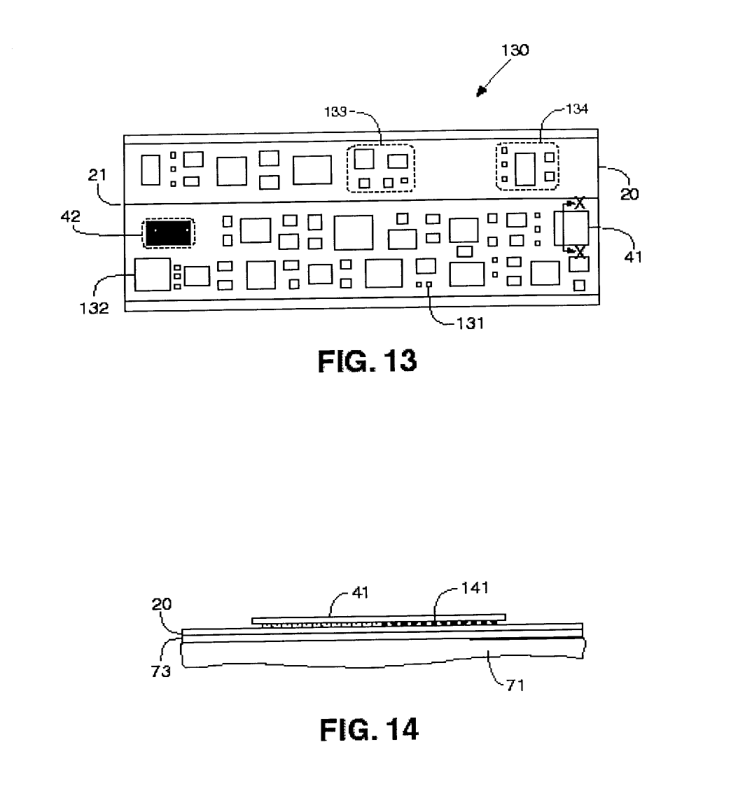

FIG. 13 shows motherboard circuit assembly 130 with multiple IC chips such as 41, and other surface-mounted components such as 131 on motherboard 20. Components 41 and 131 are preferably attached by the flip chip assembly method. Alternatively, surface-mount components may be attached using known solder re-flow techniques. Module access port 42 provides an array of module access pads (I/O pads of the module) for connection to external signals and power, as well as connection to internal nodes of the motherboard for testing purposes, as will be further described. IC chip 132 is a special-purpose test chip in the preferred embodiment, and is preferably the first chip to be assembled. For testing different circuit types, such as digital, analog, and radio frequency (RF), it may be desirable to assemble more than one special-purpose test chip. Alternatively, all forms of testing may be accomplished using external testers, accessed through module access port 42. The preferred embodiment includes speech processing group 133 and RF group 134. Group 133 preferably supports voice recognition for user voice commands or selections, and voice synthesis for aural computer responses, as are known in the art. It may also be used to process voice signatures, to confirm the identity of an authorized user. RF group 134 may include a variety of communication links for voice, data, and geo-location, as are also known in the art.

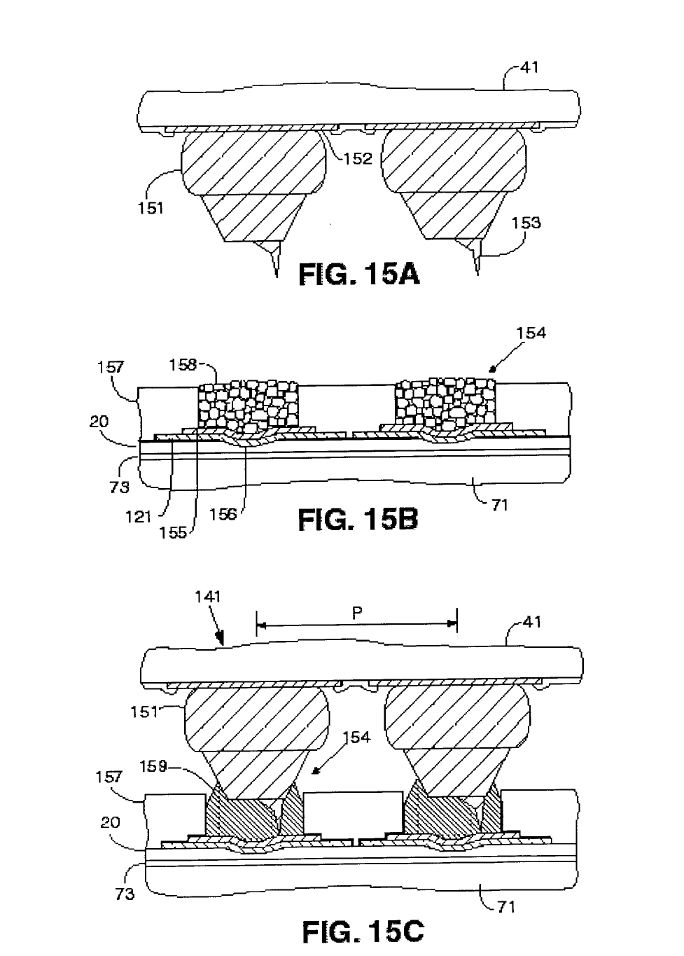

FIG. 14 represents an enlarged cross-sectional view of section XX of FIG. 13. A portion of circuit assembly 130 is supported on release layer 73 on top of glass carrier 71. It includes motherboard 20 plus attached components. IC chip 41 is attached using flip chip connections such as 141, which will be further described in reference to FIG. 15.

FIGS. 15A-15C shows a sequence of steps for creating a flip chip bond of the current invention. FIG. 15A shows that an IC chip 41 has been prepared for assembly by forming gold stud bumps such as 151 at I/O bonding pads such as 152. These stud bumps can be created using a Kulicke and Soffa 8098 bonder, using the application of heat, pressure, and ultrasonic energy. The process for forming the ball portion of the stud bump is the same as for a ball bonder. If an 18 micron diameter gold wire is used, the bonder can be configured to make stud bumps such as 151 with a ball diameter of 50 microns and an overall height of 50 microns. The “beard” 153 is created by accurately shearing the gold wire, and the tips of the beards are coplanar within ±2.5 microns. FIG. 15B shows that motherboard circuit 20 has been prepared for IC chip assembly by creating wells filled with solder such as 154 at each I/O bonding pad such as 121. Bonding pad 121 has a width of 80-100 microns, with a preferred width of 90 microns in the preferred embodiment. It has been coated with a metallization 155, to prevent diffusion of solder materials into multi-layer circuit 20, to provide an oxidation barrier, and also to provide a solder-wetting surface. An acceptable sequence of layers for metallization 155 is an adhesion layer of aluminum, a solder diffusion layer of nickel, and an oxide prevention layer plus solder wettable layer of copper. This sequence is known in the art as under bump metallization, UBM. The bottom of well 154 is depressed at the center, 156, corresponding to the shape of a stacked contact provided at the I/O pad, as described in reference to FIG. 11A. A planarizing layer of polymer material 157 such as non-photo-definable BCB is formed over the pads, at a thickness of approximately 15 microns when cured. Polymer material 157 is etched using known dry etching techniques to create openings at the wells. The openings have vertical walls, as shown in the figure. This is not generally possible using photo-polymers such as photo BCB, and this is why dry etching is used, with an anisotropic etching characteristic, as is known in the art. Polymer 157 is cured to form the solder paste mask and is typically not removed, i.e., it remains a part of the finished circuit assembly. Solder paste 158 in well 154 is laterally confined by the opening in the polymer material. Paste 158 is applied using the wiping action of a squeegee over the mask surface. In the preferred embodiment, using a large glass panel as the carrier, several million wells are typically filled with paste using one pass of the squeegee. FIG. 15C shows a completed flip chip bond 141 of the current invention, with stud bump 151 inserted into well 154. Since the height variation of the stud bumps is held to ±2.5 microns, and since the beard is a ridge of small cross-section, and since gold is a soft and malleable material, a small amount of pressure applied to an IC chip will result in the tips of the beards making uniform contact with the bottoms of the wells. The solder paste has been melted and cooled to form a permanent bond. Solder 159 forms a strong mechanical bond with beard 153 and the underside of stud bump 151, as well as a low resistance contact. The width of the well is approximately 34 microns in the preferred embodiment. The foregoing dimensions, together with the precise photolithographic patterning achievable with glass processing fabs, and the dimensional stability of the interconnection substrate (base polymer layer) with underlying glass, make a pad pitch P of less than 100 microns achievable. Examples of solder materials that are suitable for the current invention include Sn/Pb/Sb in percentages 5/95/0, 63/37/0, or 95/0/5 respectively.

The amount of paste in a well is approximately 1.5×10⁻⁷ gm in the preferred embodiment, at a material cost of approximately 10 cents/gm. The labor and equipment costs of forming wells are low for large glass carriers because several million wells are created in parallel. Included in the processing are a photolithographic step to form the solder paste mask, and wiping of a squeegee over the mask to deposit solder paste in the wells. The cost per stud bump using the Kulicke and Soffa 8098 bonder is approximately 0.03 cents, based on 200,000 bumps on an 8-inch wafer. Consequently, the cost of each flip chip connection in the current invention, including the stud bump and the corresponding well, can be less than 0.05 cents or US$0.0005. This compares with current costs per connection of around one cent or more for wire bonding and other flip chip bonding methods. Such a low cost for the current invention means that additional test points can be added to the module access port to make testing easier and more effective, perhaps decreasing the overall system cost due to testing economies.

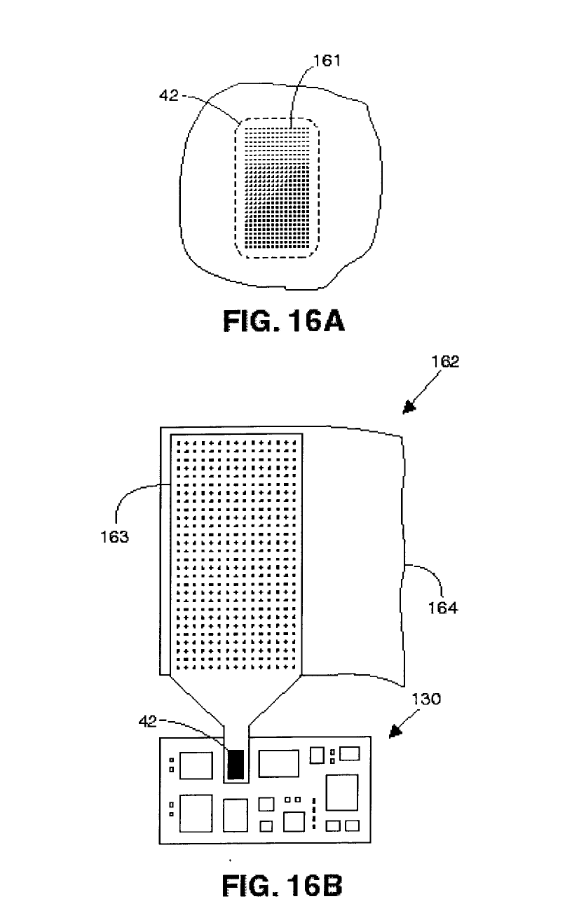

FIG. 16A represents an example of a module access port 42 with individual module access pads such as 161 arrayed as shown. The module access pads provide a means for electrical connection from motherboard 20 or from circuit assembly 130 to other electronic assemblies or devices, and include provision for data signals, control signals, and power. A circuit assembly such as 130 will typically require several different working voltages for operation. Preferably, power at the highest working voltage will be delivered through module access port 42, and local converters and regulators implemented on one or more IC chips will provide any other working voltages that are required. The converters and regulators may be programmable in order to adjust the working voltages for testing purposes. An external tester can be used to validate the integrity of the interconnection circuits prior to assembling IC chips and other components. It may be advantageous to provide a module access pad for every node on the motherboard, to provide 100% test coverage for short circuits. If a test fixture is used, as described in FIG. 16B, module access pads 161 can have a pitch of less than 100 microns, just like flip chip bonding sites 141. If a motherboard has 4000 nodes, corresponding to a medium complexity board, then the corresponding area occupied within the module access port is only 0.4 cm² at a bonding pitch of 100 microns. Some open circuit testing may also be performed on critical nets (distributed nodes). This is similar in concept to a “bed-of-nails” test that is typically performed on conventional printed circuit boards. In some cases, repair of defective interconnection circuits may be appropriate, preferably using focused ion beams, FIB.

The layout of motherboard assembly 130 is so dense, both in the fine line traces and in the fine pitch assembly, that conventional connectors and cables are not well suited for connecting to it; they would occupy a large fraction of the total module space. In FIG. 16B, a test fixture 162 is shown connecting to module access port 42 of motherboard assembly 130. A redistribution of the module access pads is provided on glass substrate 163, so as to connect conveniently via cable 164 to an external tester. A single or multi-layer interconnection circuit is patterned on glass substrate 163, with a one-to-one connection between module access pads in the module access port, and corresponding pads in the redistributed array. As previously described in reference to FIG. 15 for creating stud bumps on IC chips, so stud bumps are bonded on test fixture 162. They are provided with a pad pitch of 100 microns at the small end containing the module access port, to mate with wells filled with solder at each of the module access pads. Connection to pads in the redistributed array of test fixture 162 may be accomplished with a conventional flexible circuit, for example. Such a flex circuit may have copper conductors, and may include gold plated bumps that connect by contact with the pads of the redistributed array. The pads of the redistributed array may be enlarged, and coated with gold for a low-resistance contact. A primary purpose of test fixture 162 is to provide connection means for verifying the integrity of the multi-layer interconnections of the motherboard before any components are assembled. Secondary purposes may include testing of the motherboard assembly as each component is attached, if test chips are not provided on the motherboard. If test chips are provided, then test fixture 162 is used to connect these chips to an external tester for verification, prior to assembly of the other components. Connections to the module access port can be unmade by heating the solder and withdrawing the stud bumps. Heat can be applied using a hotplate under the glass carrier, typically bringing it to a temperature below the solder melting point, as well as applying heated inert gas to the top side of glass substrate 163. After inspection, touch up of the wells may be required. Touch up may include adding additional solder paste to the wells, or clearing displaced solder between the wells. Then another connection to the module access port can be made for a different purpose.

In the current invention a flexible module cable (not shown) is provided between module access port 42 and external fingerprint sensor 13 when the computing device is configured for operation. This cable can be partially manufactured as circuit 85 on glass carrier 71, using the same fabrication steps as followed for motherboard assembly 130. Before detaching the module cable from its glass carrier, it is stud-bumped at those pads of the module access port required for the interface of sensor 13, using a stud-bumping method similar to the method previously described for IC chips. External fingerprint sensor 13 is used as follows. When a user wants to deploy stored computing device 30 for operation, he or she applies a finger to sensor 13. Sensor 13 detects the finger and communicates with circuits on motherboard assembly 130, causing them to become active and process the sensed information. If the fingerprint data matches a previously stored replica of a registered user, then the current user is authorized, and electronic latches such as 32 allow the keyboard 3 and display 4 to be extended for use. If the user is not authorized, electronic latches 32 do not open, denying access to the computing device. In addition, the fingerprint data of the unauthorized user may be transmitted to a base station for follow-up by legal authorities, using wireless circuits provided on motherboard assembly 130.

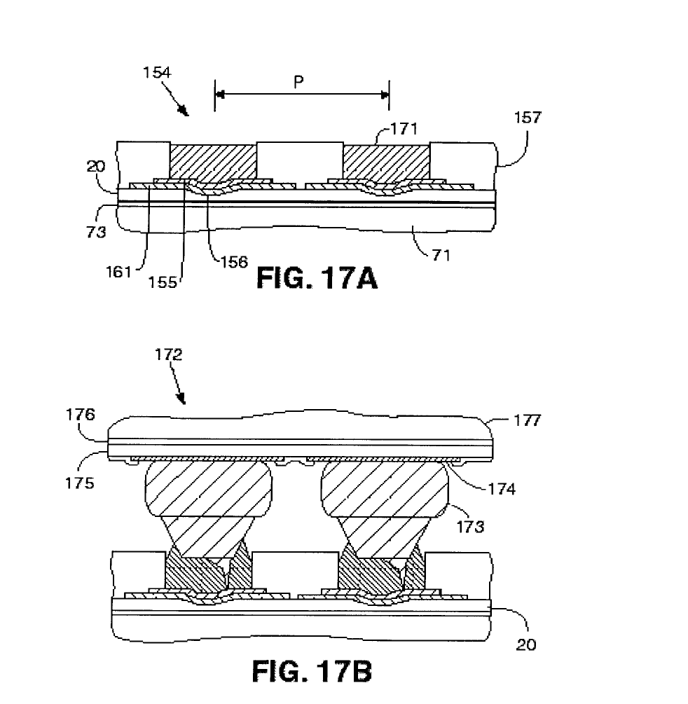

FIG. 17A-FIG. 17B show the similarity between flip chip connections 141 for connecting IC chips, already described in reference to FIG. 15, and module access port connections such as 172, shown in FIG. 17B. FIG. 17A shows motherboard circuit 20 on release layer 73 on glass carrier 71. An I/O bonding pad 161 is shown, which in this case is a module access pad. Bonding pad 161 connects to a circuit node of motherboard 20 using a stacked contact as previously described. Metallization 155 is shown over the bonding pad, as previously described. The pitch between wells such as 154 is P, which is 100 microns or less in the preferred embodiment. Well 154 is formed in polymer layer 157. It has been filled with solder paste as previously described, and the paste has been melted into solder form, 171. FIG. 17B shows an enlarged portion of a module cable or test fixture 162 inverted over the wells. Gold stud bumps 173 are bonded to metal pads 174 which sit on interconnection circuit 175 on top of release layer 176, on top of glass carrier 177 (inverted in the figure).

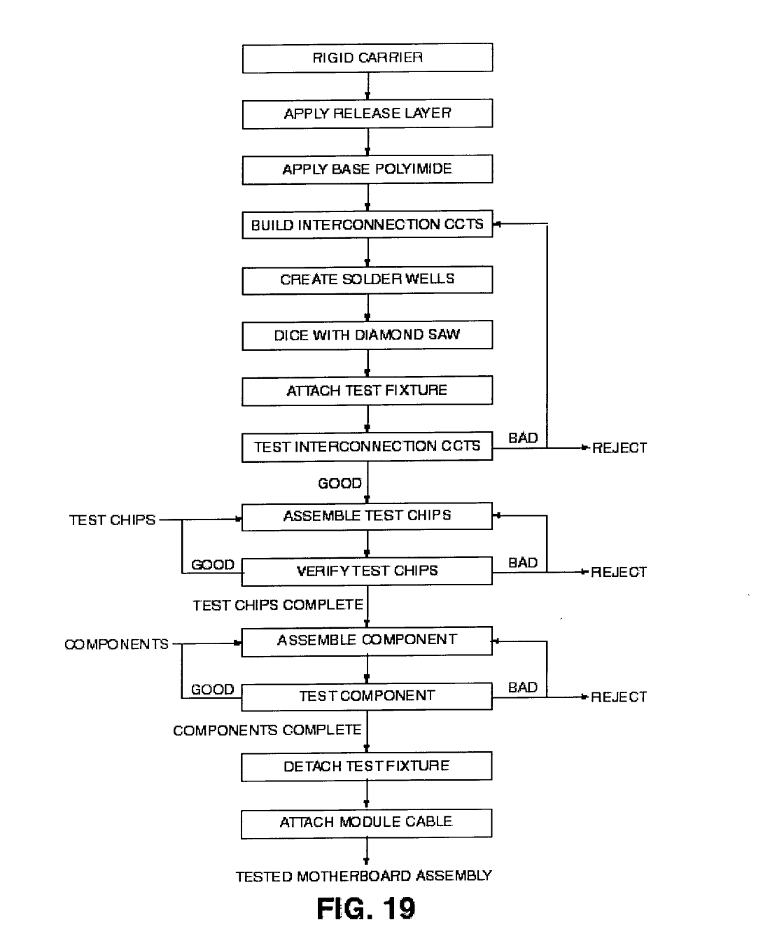

Referring back to FIG. 13, the assembly and test sequence of the electrical components such as IC chip 41 will now be discussed. Before assembling any components, a test fixture such as 162 is temporarily attached to module access port 42, with the other end connected to a tester. The motherboard is tested for opens and shorts, and rejected if defective. The first chip to be assembled is preferably test chip 132. Test chip 132 is tested by an external tester with capabilities suitable for testing both functional and parametric specifications. If defective, the test chip is replaced. It is heated by application of hot inert gas, the solder in the wells is melted, and the stud bumps lifted out of the wells. The wells are inspected, and touched up if necessary. The same procedure is used for rework of any defective IC chips. Once installed and tested, the test chip is capable of testing the remaining components at circuit speed, after each one is attached. Alternatively, each new component may be tested using an external tester, connected using test fixture 162. The testing of each added component is performed in the system environment of components that have already been assembled. If a component is defective, it is replaced before assembling the next component. If desired, testing can be performed at an elevated temperature applied to motherboard assembly 130, using a heater under the glass carrier. When motherboard assembly 130 has been completely assembled and tested, test assembly 162 is removed. The overall sequence for creating a tested motherboard assembly is presented in the form of a flow graph in FIG. 19.

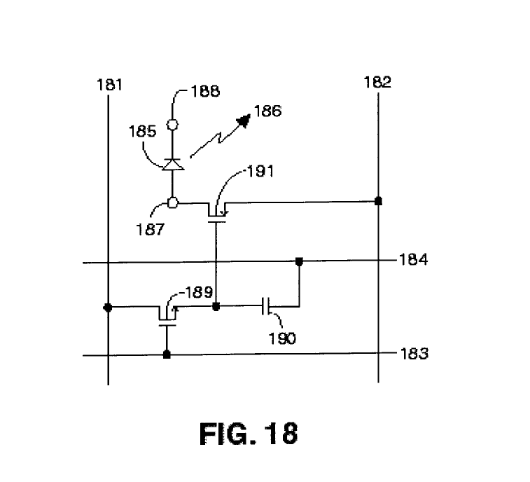

Display circuit 4 employs the same fabrication and assembly techniques as motherboard 20 as they relate to fabrication of high-density interconnection circuits, assembly of attached components such as IC chips, and assembly of test fixtures and module cables. For display 4, additional steps are required to create thin film transistor, TFT, switching elements, using methods known in the art, and to pattern the organic light emitting materials on top of the display back plane, again using methods known in the art. FIG. 18 is a schematic view of a pixel display element such as arrayed at pixel location 44, shown in FIG. 4. This example circuit follows Richard Friend, “Organic Electroluminescent Displays”, Society for Information Display, May 1999. Signal line 181 and supply line 182 are arrayed with scan line 183 and capacitor line 184. Light emitting polymer (LEP) diode 185 emits light 186 and connects between anode 187 and cathode 188. Diode 185 is a transducer that converts electrical energy in the form of an electric current passing from anode 187 to cathode 188 into light energy emitted from the diode, 186. Switching thin film transistor, TFT, 189 feeds storage capacitor 190, and drive transistor 191 sends the desired current through photodiode 185 to create illumination 186.

FIG. 19 is a summary flow chart depicting the aforementioned processes for building a tested motherboard assembly.

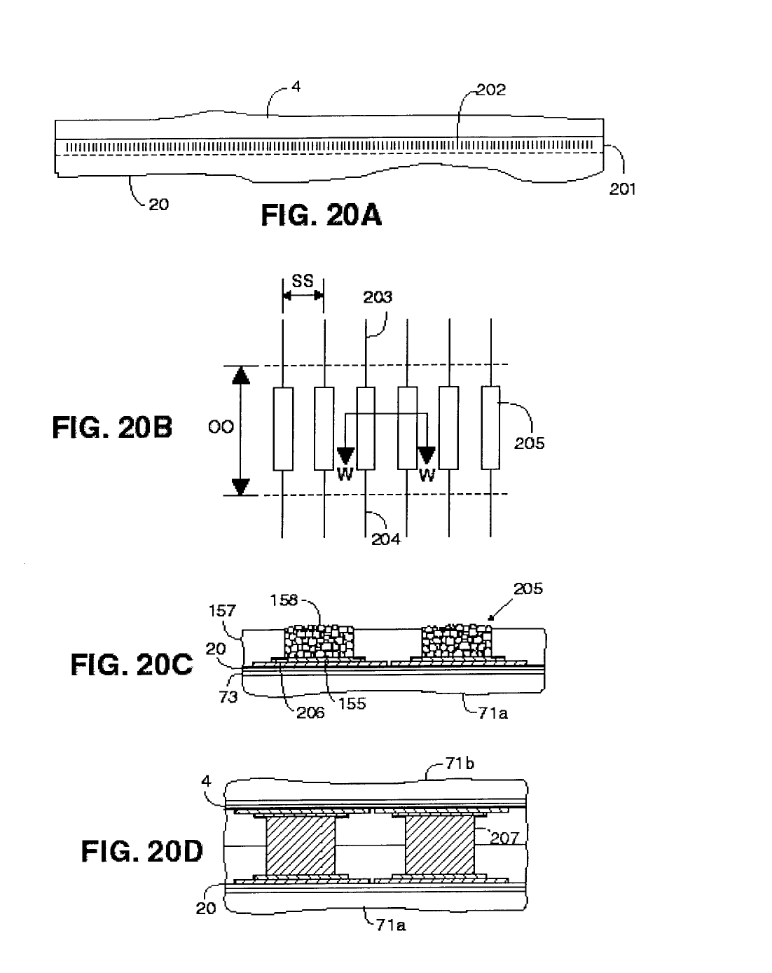

It may be desirable to communicate using a large number of signal paths between components of computing device 1. For example, it may be desirable to eliminate the requirement for TFTs in the back plane of display circuit 4. Display 4 could then be implemented as a passive reflective display (no back light). For this case it may be desirable to bus all of the row and column signals across the interface between motherboard 20 and display 4. This would total 1792 signals (1024+768), too many for the edge connector described in FIG. 5. The precision that allows a bonding pitch of less than 100 microns for IC chips and module cables can also provide for edge connections with a pitch of 200 microns or less. The cost of including such a high-density edge connection is low, because the same processing steps that were used to create wells filled with solder such as 154 for attaching IC chips can be used to create elongated wells for the edge connection. FIG. 20 shows such a high-density edge connection 201 with edge conductor pattern 202 between motherboard 20 and display 4. FIG. 20B is an expanded plan view of a segment of edge pattern 202 showing a pitch SS of 200 microns or less, and an overlap, OO, of 1 mm or less. This density is only achievable when flexible assemblies 130 and 4 are backed by their rigid carriers to provide support and dimensional stability. This means that a pair of components employing these high-density edge connections must be connected to form a single large component before detaching either of their rigid carriers. This process can be continued to connect three or more components, before the rigid carriers are removed to create the flexible version. Then the complete flexible version can be bonded to enclosure 4. FIG. 20B shows trace 203 from display 4 connecting to trace 204 of motherboard assembly 130 via elongated wells 205. FIG. 20C shows a fragment of motherboard assembly 130 representing section WW of FIG. 20B with adjacent elongated wells 205 shown filled with solder paste, 158. Polymer layer 157 has been patterned to define elongated wells 205. Elongated wells 205 are centered on elongated I/O pads 206 that are coated with intermediate metallization 155 as previously described in reference to well 154 of FIG. 15B.

FIG. 20D shows that display 4 on rigid carrier 71b has been inverted over motherboard 130 on rigid carrier 71a in the region of edge pattern 202. After aligning these two assemblies, the solder paste has been melted to form columnar contacts 207 corresponding to elongated wells 205.

The use of a super-elastic material to form a roll-up device will now be discussed. An example is display 4 which is bonded to super-elastic sheet 57 as a stiffening layer. A suitable range of thickness for super-elastic sheet 57 is 50-200 microns, with 50 microns preferred. The required thickness depends on the elastic properties of the particular material used. For example, sheets of Nitinol appear to have greater resistance to bending after being worked in a cold rolling mill to achieve the desired thickness. The preferred material is Nitinol with a glass transition temperature, Tg, of around 10° C., to provide a guard-band of 10° C. with respect to the anticipated operating temperature of 20° C. Other super-elastic materials may be used. Using Nitinol, the super-elastic behavior requires the austenite phase of the material, which is only present at temperatures above Tg. The manufacturer can adjust Tg by changing the relative amounts of Ti and Ni in the alloy. Both sides of sheet 57 should receive a pickling treatment for good bonding to adhesive layers 56 and 58 of FIG. 5C. Super-elastic properties are claimed for strains less than 4% in Nitinol alloys. In the present invention the strain is limited to 1% for the combination of a 50 micron thickness of sheet 57, and a minimum bend radius around roll up cylinder 14 of 5 mm. If true super-elastic behavior is not achieved, then after many cycles of being rolled up and expanded, display 4 will be curved rather than planar.

Super-elastic alloys such as Nitinol may be applied to components other than displays and keyboards of a computing device. For example, transducer arrays may convert electrical energy to sound energy to form speakers on a flexible substrate, with a web of support provided by super-elastic materials. Scanning antennas that roll up for storage may be built using phased arrays of sensing elements, enabled by the dense interconnection circuits and IC chip assemblies achievable with the current invention, and supported by sheets of super-elastic material. Other applications will be apparent to skilled practitioners of the art.

Cooling of the computing device will now be discussed. In the preferred embodiment, the total surface area of the enclosure, display and keyboard is approximately 700 square inches, of which approximately 500 square inches (0.32 square meters) is accessible to free-flowing ambient air. A typical value for the convective heat transfer coefficient is 10 watts per square meter per degree Centigrade. A rough order of magnitude of the cooling effect can be calculated assuming that all the surfaces are at the same temperature. With this assumption, convective cooling can sink 3.2 watts of heat per degree of temperature difference between cooling surface and ambient air. It may be reasonable to allow the cooling surfaces to be 20° C. above ambient, for example, providing 64 watts of passive cooling for the given assumptions. The heat is produced at active junctions of the IC chips and TFTs comprising the processing circuits. Referring back to FIG. 2 it can be seen that active devices are mounted directly on cooling surfaces such as enclosure 2 and roll up devices 3 and 4. With no intermediate packaging layers there is a short thermal path from each active device to one of the cooling surfaces. The short thermal path means that junction temperatures will be closely coupled and will tend to track in temperature. The total rate of heat generation can be controlled by varying system speed. It is assumed that unused devices are turned off. In the preferred embodiment of a mobile version of the computing device, the user interface includes a setting for maximum operating temperature of the exposed surfaces. As the system heats up the controller can lower its own speed and the speed of other system devices, keeping the exposed working surfaces within the desired temperature limit.

What is claimed is:

1. A roll up device comprising:
conductive traces on a flexible substrate,
sensor or transducer elements connected to said conductive traces,
a layer of super-elastic material bonded to said flexible substrate, and,
a means to roll up said roll up device for storage, and release it for use.

2. The roll up device of claim 1 wherein said super-elastic material includes Ni and Ti.

3. The roll up device of claim 1 wherein said sensor elements include capacitive sensing elements for keyboard elements, touch pads, or fingerprint sensors.

4. The roll up device of claim 1 wherein said transducer elements include light emitting devices.

5. An electronic device comprising:
an enclosure and,
at least one roll up device that can be rolled into said enclosure and rolled out from said enclosure and including super-elastic materials for stiffening.

6. The electronic device of claim 5 and further including a motherboard connected to said roll up device, said motherboard including means for providing data or control information to said roll up device or receiving data or control information from said roll up device.

7. The electronic device of claim 6 wherein said motherboard includes integrated circuit chips mounted on a flexible interconnection circuit.

8. A computing device comprising:
a motherboard having processing circuits,
a roll up keyboard device connected to said motherboard and providing user input data to said processing circuits, and,
a roll up display device connected to said motherboard and displaying visual information generated or controlled by said processing circuits.

9. A computing device comprising:
processing circuits for interpreting voice commands and for responding to said voice commands with visual information,
a roll up display device connected to said processing circuits for displaying said visual information in response to said voice commands.

10. The computing device of claim 8 or claim 9 and further including a lens and image sensor that cooperate with said processing circuits to generate images.

11. A method for providing an edge connection between conductive traces on two flexible circuits comprising the steps of:
providing rigid carriers for each of said flexible circuits,
providing an edge pattern of said conductive traces on each of said flexible circuits with a predetermined trace pitch,
patterning a polymer film on each of said flexible circuits to create openings at said edge patterns, each of said openings overlapping one of said conductive traces,
filling said openings with solder paste,
aligning said flexible circuits face-to-face,
heating said solder paste to form molten solder, and,
cooling said molten solder to form a permanent edge connection at each of said conductive traces.

12. An edge connection between two flexible circuits comprising:
conductive traces on each of said flexible circuits arranged in an edge pattern with a predetermined trace pitch,
each of said flexible circuits having a patterned polymer film at said edge pattern, each of said openings overlapping one of said conductive traces,
solder filling said openings,
a face-to-face relation between said flexible circuits at said edge connection such that solder in said openings connects between corresponding conductive traces on each of said flexible circuits.

13. The edge connection of claim 12 wherein said predetermined trace pitch is 200 microns or less.

14. A flat keyboard device comprising:
a set of keys on a flat surface,
capacitive means to detect activation of said keys, and,
said keys on said surface are delineated using texturing of said flat surface in areas surrounding each of said keys.

15. A flat keyboard device comprising:
a back plane of interconnection circuits including thin film transistors, and,
an array of capacitive sensors connected to said interconnection circuits.

16. An integrated keyboard device comprising:
a set of keys for typing, each key comprising one or more electrodes connected to circuit elements using thin film transistors, and,
a fingerprint sensor with an array of electrodes connected to circuit elements using thin film transistors, wherein said keys and said fingerprint sensor are fabricated on a single monolithic substrate.

17. An integrated keyboard device comprising:
a set of keys for typing, each key comprising one or more electrodes connected to circuit elements using thin film transistors,
a fingerprint sensor comprising an array of electrodes connected to circuit elements using thin film transistors, and,
a touch pad comprising an array of electrodes connected to circuit elements using thin film transistors, wherein said keys, said fingerprint sensor, and said touch pad are all fabricated on a single monolithic substrate.

18. A secure computing device comprising:
said computing device having a stored configuration and an expanded configuration, wherein computing services are available in said expanded configuration but are not available in said stored configuration,
an electronic latch for locking said computing device in said stored configuration,
a fingerprint sensor available in said storage configuration for establishing whether or not a user is authorized, and,
control means for locking and unlocking said electronic latch to deny or provide access by said user to said computing device.

19. A secure computing device comprising:
said computing device having a stored configuration and an expanded configuration, wherein computing services are available in said expanded configuration but are not available in said stored configuration,
an electronic latch for locking said computing device in said stored configuration,
capability in said stored configuration to analyze a voice signature for establishing whether or not a user is authorized, and,
control means for locking and unlocking said electronic latch to deny or provide access by said user to said computing device.

20. A passively cooled computing device comprising:
roll up devices including arrays of sensors or transducers having cooling surfaces exposed to ambient air when extended for use, said sensors or transducers connected to processing circuits of said computing device,
a short thermal path from said cooling surfaces to said sensors, transducers and processing circuits, and,
said processing circuits include control means for limiting the maximum temperature of said cooling surfaces.
